(19) United States
(12) Patent Application Publication
(10) Pub. No.: US 2026/0188637 A1
(43) Pub. Date: Jul. 2, 2026

(54) THERMAL DESORPTION DIRECT ANALYSIS ION SOURCE

(71) Applicants: Ningbo University, Ningbo (CN); Ningbo Zhenhai Institute of Mass Spectrometry, Ningbo (CN)

(72) Inventors: Jiancheng Yu, Ningbo (CN); Dekai Yang, Ningbo (CN); Feng Xu, Ningbo (CN); Chenlu Wang, Ningbo (CN); Yong Wu, Ningbo (CN); Wenqing Gao, Ningbo (CN); Keqi Tang, Ningbo (CN)

(21) Appl. No.: 19/426,101

(22) Filed: Dec. 19, 2025

(30) Foreign Application Priority Data
Dec. 26, 2024 (CN) 202411933207.4

(51) Int. Cl. H01J 49/16

(52) U.S. Cl. CPC H01J 49/16

(57) ABSTRACT

A thermal desorption inlet ion source with separation function includes: an ionization chamber, a heating chamber, a sample inlet system, a heating system, an ionization element, a detection element, and a waste liquid. A thermal insulation pad is detachably connected to a top of the ionization chamber. The heating chamber is fixed onto a top of the thermal insulation pad. A mounting base is mounted at a bottom inside the heating chamber. A sample inlet unit is mounted on a top of the heating chamber. A sample inlet tube is fixedly connected to the mounting base. The heating system is mounted on the mounting base. The ionization element is fixed perpendicularly to a side wall of the ionization chamber, and the detection element is fixed perpendicularly to another side wall thereof. The waste liquid is disposed on a bottom of the ionization chamber.

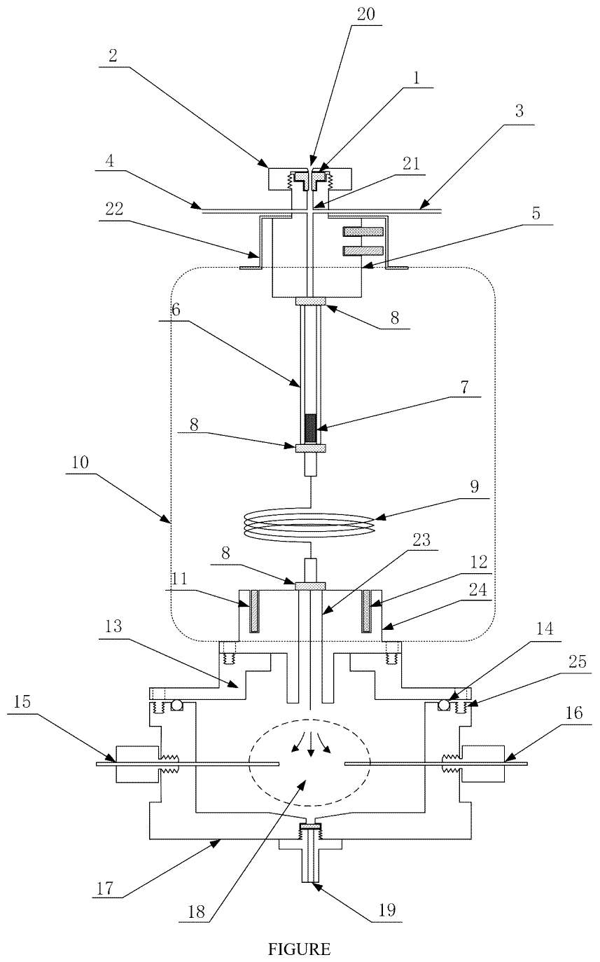

### CROSS-REFERENCE TO RELATED APPLICATION

This application claims priority to Chinese Patent Application No. 202411933207.4, filed on Dec. 26, 2024, which is herein incorporated by reference in its entirety.

### TECHNICAL FIELD

The disclosure relates to the field of sub-atmospheric pressure ion sources, and more particularly to a thermal desorption inlet ion source with separation function, which refers to a type of thermal desorption direct analysis ion source.

### BACKGROUND

In an experiment of thermal desorption electrospray ionization mass spectrometry, a sample to be tested needs to be ionized, and resulting ions are introduced into a mass spectrometer for detection. Traditional gas chromatography-mass spectrometers and liquid chromatography-mass spectrometers, due to their requirement for complex sample preparation and separation by gas chromatography or liquid chromatography, typically require several hours to complete a single analysis. Moreover, these spectrometers are large in size and are suitable for laboratory use.

An atmospheric pressure ionization (API) source ionizes the sample to be tested at atmospheric pressure, allowing the sample to be introduced directly into the mass spectrometer at the atmospheric pressure for analysis, thereby providing a possibility for rapid on-site detection. Currently, the API source can be used for rapid analysis of on-site samples, and a single analysis generally takes only a few tens of seconds. Typical API sources include, but are not limited to, desorption electrospray ionization (DESI) sources, direct analysis in real time (DART) sources, and thermal desorption atmospheric pressure chemical ionization (TD-APCI) sources. However, these ionization sources generally lack separation functions. After ionization, a large number of ions are generated simultaneously, and multiple components are ionized at the same time, which readily leads to ionization competition among the components and affects the detection of low-abundance target compounds. Since concentrations of targets in clinical drugs, biological specimens, and wastewater are typically very low, an existing portable mass spectrometer often yields measurement results with a high probability of false positives and false negatives when facing the low-concentration detection targets.

In view of this, Bruker provides a gas chromatography-atmospheric pressure chemical ionization-mass spectrometer (GC-APCI-MS) with a separation function designed for laboratory use. This mass spectrometer employs a conventional gas chromatography mode for its carrier gas. However, it still suffers from drawbacks of large size, long separation times, and high power consumption.

Based on the above technical problems, the disclosure provides a thermal desorption inlet ion source with separation function.

### SUMMARY

A purpose of the disclosure is to provide a thermal desorption inlet ion source with separation function to solve problems existing in the related art.

To achieve the above purpose, the disclosure provides the following technical solution: a thermal desorption inlet ion source with separation function, which includes an ionization chamber, a heating chamber, a sample inlet system, a heating system, an ionization element, a detection element, and a waste liquid.

A thermal insulation pad is detachably connected to a top of the ionization chamber.

The heating chamber is fixed onto a top of the thermal insulation pad, and a mounting base is mounted at a bottom inside the heating chamber.

The heating chamber is equipped with a sample inlet unit mounted on a top of the heating chamber. A sample inlet tube is fixedly connected to the mounting base, and the sample inlet tube passes through the heating chamber and the thermal insulation pad and extends into the ionization chamber. The sample inlet unit and the sample inlet tube are connected through a sample-separation column.

The heating system is mounted on the mounting base.

The ionization element is fixed perpendicularly onto a side wall of the ionization chamber, and the ionization element is arranged perpendicular to the sample inlet tube.

The detection element is fixed perpendicularly onto another side wall of the ionization chamber, and the detection element is arranged corresponding to the ionization element.

The waste liquid outlet is disposed on a bottom of the ionization chamber, and an ionization region is formed among the ionization element, the detection element and the sample inlet tube.

According to the thermal desorption inlet ion source with separation function provided by the disclosure, the sample inlet unit includes a fixing base, a connecting tube, a filter assembly, a glass liner tube, a filter material, a sample inlet heating device, a solvent injection tube, and a gas inlet tube. The fixing base is fixedly connected to the top of the heating chamber. The connecting tube is vertically and fixedly connected to the fixing base. The filter assembly is mounted onto a top end of the connecting tube. The glass liner tube is fixedly connected to a bottom end of the connecting tube. The filter material is filled into the glass liner tube. The sample inlet heating device is mounted on an outer wall of the connecting tub and is fixed onto the fixing base. The solvent injection tube and the gas inlet tube are fixedly connected to a side wall of the top end of the connecting tube.

According to the thermal desorption inlet ion source with separation function provided by the disclosure, a sealing ring is disposed between the thermal insulation pad and the heating chamber.

According to the thermal desorption inlet ion source with separation function provided by the disclosure, the sample-separation column is a capillary column, and two ends of the capillary column are fixedly connected to the glass liner tube and the sample inlet tube, respectively.

According to the thermal desorption inlet ion source with separation function provided by the disclosure, sealing connectors are detachably connected to a top end of the sample inlet tube and two ends of the glass liner tube, respectively. The two ends of the capillary column are fixedly connected to two of the sealing connectors, respectively.

According to the thermal desorption inlet ion source with separation function provided by the disclosure, the heating system includes a heating rod and a temperature measuring rod, and the heating rod and the temperature measuring rod each is fixedly connected to the mounting base.

According to the thermal desorption inlet ion source with separation function provided by the disclosure, the filter assembly includes a septum and a retaining nut. The septum is seated on the top end of the connecting tube, and the retaining nut is threadedly connected to the top end of the connecting tube. The retaining nut is formed with a through-hole at a middle of the retaining nut. The septum is disposed between the retaining nut and the connecting tube.

According to the thermal desorption inlet ion source with separation function provided by the disclosure, the filter material includes a quartz-wool plug, and the quartz-wool plug is filled inside the glass liner tube.

According to the thermal desorption inlet ion source with separation function provided by the disclosure, the ionization chamber is made of metal, and the thermal insulation pad is made of ceramic. The thermal insulation pad is fixed onto the top of the ionization chamber by securing bolts.

The disclosure may achieve the following technical effects.

In the thermal desorption inlet ion source with separation function of the disclosure, the sample-separation column of a certain length is introduced between the sample inlet unit and the sample inlet tube. Since different components in a sample have different partition coefficients between a stationary phase and a mobile phase, their migration speeds within the sample-separation column also differ. A component with a smaller partition coefficient has a higher concentration in the mobile phase and therefore migrates faster, and a component with a larger partition coefficient has a higher concentration in the stationary phase and migrates slower, thereby achieving separation. Unlike conventional ion sources, the thermal desorption inlet ion source with separation function of the disclosure employs air as carrier gas, which achieves an integrated and miniaturized design while maintaining its sensitivity and detection speed, thereby enabling rapid on-site detection.

The thermal desorption inlet ion source with separation function of the disclosure incorporates the sample-separation column between the sample inlet unit and the sample inlet tube. The mobile phase carries sample molecules through the sample-separation column for rapid separation, followed by detection. This configuration can significantly reduce ionization competition for target compounds in the atmospheric pressure ion source, thereby improving sensitivity and quantitative stability, and enabling more precise rapid detection.

### BRIEF DESCRIPTION OF DRAWING

To more clearly illustrate technical solutions in embodiments of the disclosure or in the related art, an attached drawing required in the embodiments is briefly described below. Apparently, the attached drawing described below is merely some embodiments of the disclosure. For those skilled in the art, other attached drawings can also be obtained according to the attached drawing without creative efforts.

FIGURE illustrates a schematic structural diagram of a thermal desorption inlet ion source with separation function of the disclosure.

### DESCRIPTION OF REFERENCE SIGNS

1—septum; 2—retaining nut; 3—solvent injection tube; 4—gas inlet tube; 5—sample inlet heating device; 6—glass liner tube; 7—quartz-wool plug; 8—sealing connector; 9—capillary column; 10—heating chamber; 11—temperature measuring rod; 12—heating rod; 13—thermal insulation pad; 14—sealing ring; 15—ionization element; 16—detection element; 17—ionization chamber; 18—ionization region; 19—waste liquid outlet; 20—through-hole; 21—connecting tube; 22—fixing base; 23—sample inlet tube; 24—mounting base; 25—securing bolt.

### DETAILED DESCRIPTION OF EMBODIMENTS

Technical solutions of embodiments of the disclosure will be described clearly and completely below with reference to the attached drawing in the embodiments. Apparently, the described embodiments are merely some embodiments of the disclosure, rather than all embodiments of the disclosure. Based on the described embodiments of the disclosure, all other embodiments obtained by those skilled in the art without creative efforts fall within the scope of protection of the disclosure.

To make the above-mentioned purpose, features, and advantages of the disclosure more apparent and understandable, the disclosure is further described in detail below with reference to the attached drawing and specific embodiments.

As shown in figure, the disclosure provides a thermal desorption inlet ion source with separation function, which includes an ionization chamber 17, a heating chamber 10, a sample inlet system, a heating system, an ionization element 15, a detection element (also referred to as detector) 16, and a waste liquid outlet 19.

A thermal insulation pad 13 is detachably connected to a top of the ionization chamber 17.

The heating chamber 10 is fixed onto a top of the thermal insulation pad 13, and a mounting base 24 is mounted at a bottom inside the heating chamber 10.

The sample inlet system includes a sample inlet unit, a sample inlet tube 23, and a sample-separation column. The sample inlet unit is mounted on a top of the heating chamber 10. The sample inlet tube 23 is fixedly connected to the mounting base 24, and the sample inlet tube 23 passes through the heating chamber 10 and the thermal insulation pad 13 and extends into the ionization chamber 17. The sample inlet unit and the sample inlet tube 23 are connected through the sample-separation column.

The heating system is mounted on the mounting base 24.

The ionization element 15 is fixed perpendicularly onto a side wall of the ionization chamber 17, and the ionization element 15 is arranged perpendicular to the sample inlet tube 23.

The detection element 16 is fixed perpendicularly onto another side wall of the ionization chamber 17, and the detection element 16 is arranged corresponding to the ionization element 15.

The waste liquid outlet 19 is disposed on a bottom of the ionization chamber 17, and an ionization region 18 is formed among the ionization element 15, the detection element 16 and the sample inlet tube 23.

In the thermal desorption inlet ion source with separation function of the disclosure, the sample-separation column of a certain length is introduced between the sample inlet unit and the sample inlet tube 23. Since different components in a sample have different partition coefficients between a stationary phase and a mobile phase, their migration speeds within the sample-separation column also differ. A component with a smaller partition coefficient has a higher concentration in the mobile phase and therefore migrates faster, and a component with a larger partition coefficient has a higher concentration in the stationary phase and migrates slower, thereby achieving separation. Unlike conventional ion sources, the thermal desorption inlet ion source with separation function of the disclosure employs air as carrier gas, which achieves an integrated and miniaturized design while maintaining its sensitivity and detection speed, thereby enabling rapid on-site detection.

The thermal desorption inlet ion source with separation function of the disclosure incorporates the sample-separation column between the sample inlet unit and the sample inlet tube 23. The mobile phase carries sample molecules through the sample-separation column for rapid separation, followed by detection. This configuration can significantly reduce ionization competition for target compounds in the atmospheric pressure ion source, thereby improving sensitivity and quantitative stability, and enabling more precise rapid detection.

In a specific embodiment, the sample inlet unit includes a fixing base 22, a connecting tube 21, a filter assembly, a glass liner tube 6, a filter material, a sample inlet heating device 5, a solvent injection tube 3, and a gas inlet tube 4. The fixing base 22 is fixedly connected to the top of the heating chamber 10. The connecting tube 21 is vertically and fixedly connected to the fixing base 22. The filter assembly is mounted onto a top end of the connecting tube 21. The glass liner tube 6 is fixedly connected to a bottom end of the connecting tube 21. The filter material is filled into the glass liner tube 6. The sample inlet heating device 5 is mounted on an outer wall of the connecting tube 21 and is fixed onto the fixing base 22. The solvent injection tube 3 and the gas inlet tube 4 are fixedly connected to a side wall of the top end of the connecting tube 21.

In a specific embodiment, a sealing ring 14 is disposed between the thermal insulation pad 13 and the heating chamber 10.

In a specific embodiment, the sample-separation column is a capillary column 9, and two ends of the capillary column 9 are fixedly connected to the glass liner tube 6 and the sample inlet tube 23, respectively.

In a specific embodiment, sealing connectors 8 are detachably connected to a top end of the sample inlet tube 23 and two ends of the glass liner tube 6, respectively. The two ends of the capillary column 9 are fixedly connected to two of the sealing connectors 8, respectively.

In a specific embodiment, the heating system includes a heating rod 12 and a temperature measuring rod 11, and the heating rod 12 and the temperature measuring rod 11 each is fixedly connected to the mounting base 24.

In a specific embodiment, the filter assembly includes a septum 1 and a retaining nut 2. The septum 1 is seated on the top end of the connecting tube 21, and the retaining nut 2 is threadedly connected to the top end of the connecting tube 21. The retaining nut 2 is formed with a through-hole 20 at a middle of the retaining nut 2. The septum 1 is disposed between the retaining nut 2 and the connecting tube 21.

In a specific embodiment, the filter material includes a quartz-wool plug 7, and the quartz-wool plug 7 is filled inside the glass liner tube 6.

In a specific embodiment, the ionization chamber 17 is made of metal, and the thermal insulation pad 13 is made of ceramic. The thermal insulation pad 13 is fixed onto the top of the ionization chamber 17 by securing bolts 25.

During operation, air purified by an activated carbon filter to remove organic compounds is used as the carrier gas. A flow rate of the carrier gas is regulated by a flow rate control unit (such as a damping orifice, an electronic flow controller (EFC), or an electronic pressure controller (EPC), with the flow rate being controlled within a range of 0 to 1000 milliliters per minute (mL/min)). The heating chamber 10 and the sample inlet assembly are heated to an appropriate temperature range by the heating rod 12. A waste liquid pump is connected to the waste liquid outlet 19, a syringe pump is connected to the solvent injection tube 3, and a gas supply device is connected to the gas inlet tube 4. Then, the gas supply device, the waste liquid pump, and the syringe pump are activated in sequence, and a flow rate of solvent, the flow rate of the carrier gas, and a pumping speed of the waste liquid pump are set accordingly. Then, a high voltage is applied to a corona needle (of the ionization element 15) through a mass spectrometer, and the mass spectrometer initiates operation of the detection element 16. At this point, ionization signals can be observed in a mass spectrum, which represent electronic noise (i.e., background ionization signal), indicating the thermal desorption inlet ion source with separation function of the disclosure is ready for sample injection. A sample of a certain volume is drawn into a syringe needle, which is then inserted through the through-hole 20 in the retaining nut 2, piercing the septum 1 to enter the connecting tube 21. The sample inlet heating device 5 heats the sample, causing the sample and the injected solvent to vaporize at high temperature, forming gaseous molecules. Driven by the carrier gas flow from the gas supply device, gaseous molecules of the sample pass through the glass liner tube 6 and into capillary column 9. Inside the capillary column 9, based on chromatographic principles, the sample is separated, and different components of the sample enter the ionization chamber 17 sequentially according to their retention times. The corona needle of the ionization element 15 ionizes the target sample to generate gas-phase ions. These target gas-phase ions are rapidly drawn into the detection element 16 under high vacuum, and corresponding sample peaks can be observed at the mass spectrometer. The sample detection time increases with increasing sample concentration. The operation can be concluded and the detection element 16 is stopped when a detection signal, manifested as a height of the sample peak in the mass spectrum, becomes consistent with the background ionization signal prior to sample injection. At this point, a next sample can be injected directly. If no further sample injection is required, the flow rates of the injected solvent and the carrier gas are increased to rapidly complete purging. This ionization source mode is not limited to chemical ionization sources but is also compatible with other external ion sources such as electrospray ionization (ESI) sources, dielectric barrier discharge ionization (DBDI) sources, DART sources, extractive electrospray ionization (EESI) sources, glow discharge (GD) sources, laser ionization sources, and single-photon ionization sources.

In the description of the disclosure, it should be understood that terms such as “longitudinal”, “transverse”, “upper”, “lower”, “front”, “rear”, “left”, “right”, “vertical”, “horizontal”, “top”, “bottom”, “inner” and “outer” as used to indicate orientations or positional relationships, are based on orientations or positional relationships shown in the attached drawing. These terms are employed solely for the convenience of describing the disclosure and do not indicate or imply that a device or an element referred to must have a specific orientation, be constructed and operated in the specific orientation. Therefore, these terms are not to be construed as limitations on the disclosure.

The embodiments described above are merely specification implementations of the disclosure and are not intended to limit the scope of the disclosure. Without departing from the design spirit of the disclosure, various modifications and improvements made by those skilled in the art to the technical solutions of the disclosure shall fall within the scope of protection defined by the appended claims of the disclosure.

What is claimed is:

1. A thermal desorption inlet ion source with separation function, comprising:
an ionization chamber (17), wherein a thermal insulation pad (13) is detachably connected to a top of the ionization chamber (17);
a heating chamber (10), fixed onto a top of the thermal insulation pad (13), wherein a mounting base is mounted at a bottom inside the heating chamber (10);
a sample inlet system, wherein the heating chamber (10) is equipped with a sample inlet unit mounted on a top of the heating chamber (10), a sample inlet tube is fixedly connected to the mounting base, the sample inlet tube passes through the heating chamber (10) and the thermal insulation pad (13) and extends into the ionization chamber (17), and the sample inlet unit and the sample inlet tube are connected through a sample-separation column;
a heating system, mounted on the mounting base;
an ionization element (15), fixed perpendicularly onto a side wall of the ionization chamber (17), wherein the ionization element (15) is arranged perpendicular to the sample inlet tube; and
a detection element (16), fixed perpendicularly onto another side wall of the ionization chamber (17), wherein the detection element (16) is arranged corresponding to the ionization element (15);
wherein a waste liquid outlet (19) is disposed on a bottom of the ionization chamber (17), and an ionization region (18) is formed among the ionization element (15), the detection element (16) and the sample inlet tube;
wherein the sample inlet unit comprises a fixing base fixedly connected to the top of the heating chamber (10), a connecting tube vertically and fixedly connected to the fixing base, a filter assembly mounted onto a top end of the connecting tube, a glass liner tube (6) fixedly connected to a bottom end of the connecting tube, a filter material is filled into the glass liner tube (6), a sample inlet heating device (5) mounted on an outer wall of the connecting tube and fixed onto the fixing base, and a solvent injection tube (3) and a gas inlet tube (4) fixedly connected to a side wall of the top end of the connecting tube;
wherein the sample-separation column is a capillary column (9), and two ends of the capillary column (9) are fixedly connected to the glass liner tube (6) and the sample inlet tube, respectively; and
wherein sealing connectors (8) are detachably connected to a top end of the sample inlet tube and two ends of the glass liner tube (6), respectively, and the two ends of the capillary column (9) are fixedly connected to two of the sealing connectors (8), respectively.

2. The thermal desorption inlet ion source with separation function as claimed in claim 1, wherein a sealing ring (14) is disposed between the thermal insulation pad (13) and the heating chamber (10).

3. The thermal desorption inlet ion source with separation function as claimed in claim 1, wherein the heating system comprises a heating rod (12) and a temperature measuring rod (11), and the heating rod (12) and the temperature measuring rod (11) each is fixedly connected to the mounting base.

4. The thermal desorption inlet ion source with separation function as claimed in claim 2, wherein the filter assembly comprises a septum (1) and a retaining nut (2), the septum (1) is seated on the top end of the connecting tube, and the retaining nut (2) is threadedly connected to the top end of the connecting tube, the retaining nut (2) is formed with a through-hole at a middle of the retaining nut (2), and the septum (1) is disposed between the retaining nut (2) and the connecting tube.

5. The thermal desorption inlet ion source with separation function as claimed in claim 2, wherein the filter material comprises a quartz-wool plug (7), and the quartz-wool plug (7) is filled inside the glass liner tube (6).

6. The thermal desorption inlet ion source with separation function as claimed in claim 1, wherein the ionization chamber (17) is made of metal, the thermal insulation pad (13) is made of ceramic, and the thermal insulation pad (13) is fixed onto the top of the ionization chamber (17) by securing bolts.
